(19) United States
(12) Patent Application Publication
(10) Pub. No.: US 2008/0000943 A1
(43) Pub. Date: Jan. 3, 2008

(54) Stitching device for stitching printed products

(75) Inventor: Josef Keist, Nebikon LU (CH)

Correspondence Address: Friedrich Kueffner, Suite 910, 317 Madison Avenue, New York, NY, 10017, US

(73) Assignee: Muller Martini Holding AG

(21) Appl. No.: 11/820,869

(22) Filed: Jun. 21, 2007

(30) Foreign Application Priority Data
Jun. 23, 2006 (EP) 064 05 269.9-2304

(51) Int. Cl. B25C 5/08

(52) U.S. Cl. 227/139

(57) ABSTRACT

A stitching device for stitching printed products includes a stitching head for preforming a staple and for driving the staple through a product spine, and a clincher with clincher plates for bending back the open ends of the staple. At least one part is produced at least partly of ceramic. The part may be a sintered molded part, and the ceramic may be of an oxide ceramic. The use of a part of this type makes it possible to increase the service life and to reduce costs.

### BACKGROUND OF THE INVENTION

1. Field of the Invention

The present invention relates to a stitching device for stitching printed products, with a stitching head, which has a driver and a bender to preform a staple and to drive it through a product spine, and with a clincher, which has clincher plates to bend back the open ends of the staples.

2. Description of the Related Art

Stitching devices of this type are used, for example, in gatherer-stitchers for stitching signatures. In a gatherer-stitcher of this type, the signatures are conveyed on a gathering chain, for example, on which they rest like saddles. The stitching head is positioned above the gathering chain, and the clincher is positioned below it. In the stitching head, the free ends of a piece of wire are bent back by the benders, and the two ends are driven through the product spine by the driver. Finally, the free ends are bent back 900 by the clincher, so that they end up parallel to the product spine, and the staple is thus closed.

A stitching device of this type is disclosed, for example, in CH 549 443 A. This device can be used to stitch signatures with staples. Other stitching devices are disclosed in CH 662 987 A and EPO 958 942 A.

Stitching devices of the aforementioned type are subjected to extreme loads, especially their moving and accelerating parts. Therefore, these kinds of parts must be replaced after a certain amount of time. Efforts have long been made to reduce wear and thus maintenance and costs by using high-quality parts made of steel and hard metal or cemented carbide alloy. The parts should also have a high degree of dimensional precision to ensure functional reliability. To accomplish this, these kinds of parts have previously been produced from tool steel or hard metal. Hard metal would be especially suitable in itself, since the parts produced from it last for a very long time. However, hard metal is brittle and can be destroyed during installation or shipping. Moreover, the parts are relatively expensive.

### SUMMARY OF THE INVENTION

The object of the invention is to create a stitching device of the type described indicated above which avoids the disadvantages mentioned.

This object is achieved in a stitching device of the general type indicated above by producing at least one part at least partly from ceramic.

The use of ceramic parts can significantly increase the service life. This is especially the case when the highly stressed parts, such as especially the driver, the benders, and the clincher or the parts of the clincher, are made of ceramic. Surprisingly, tests have revealed that parts of this type show essentially no damage even after 8 million stitchings. In addition, it is advantageous that testing costs are reduced due to the constant higher material quality. Since ceramic parts of this type are not sensitive to shock, they can hardly be damaged at all compared to parts made of hard metal. When these parts are subjected to high acceleration, the forces which are generated are weaker because the density of ceramic is lower than that of steel. Other important advantages are high surface quality; uniform, constant hardness; high heat resistance; lower thermal, expansion; more uniform structure; and low production costs. A further advantage is that ceramic can be paired with other materials. The parts can thus be made out of a combination of, for example, ceramic and steel or ceramic and hard metal.

According to a modification of the invention, the part produced from ceramic can be a sintered molded part. This makes it possible to achieve an especially high degree of dimensional precision and thus functional reliability. Parts to be replaced are thus completely compatible with the old parts.

In a modification of the invention, the part is produced from an oxide ceramic. Especially high durability can be achieved with a ceramic part made of oxide ceramic. In a modification of the invention, this is also the case when the part is produced from a mixed-metal oxide ceramic. An example of a suitable mixed-metal oxide ceramic is aluminum titanate.

According to a modification of the invention, the part is made up of at least two parts permanently connected to each other, one of the parts being produced from ceramic, the other from a different material, especially steel or hard metal. The ceramic is intended especially for the areas that are highly stressed and subject to wear.

The ceramic part is especially a driver, a clincher plate, a bender, a centering foot, a connecting rod, a wire nozzle, a wire cutter, or a wire shearing lever. These parts are generally highly stressed and subject to severe abrasion. In addition, they are highly accelerated during each stitching operation. The service life of a part of this type can be increased and maintenance simplified merely by producing this part from ceramic.

According to a modification of the invention, the ceramic part is an injection-molded ceramic part. Parts of this type can also be mass-produced at relatively low cost and with a high degree of dimensional precision.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a partial cross-sectional view of an inventive stitching device according to the invention;

FIG. 2 is a different view of the stitching device;

FIG. 3 is a perspective view of the stitching device;

FIG. 4 is a perspective view of part of the stitching device;

FIGS. 5a and 5b are perspective views of a clincher plate; and

FIG. 6 is a perspective view of a driver.

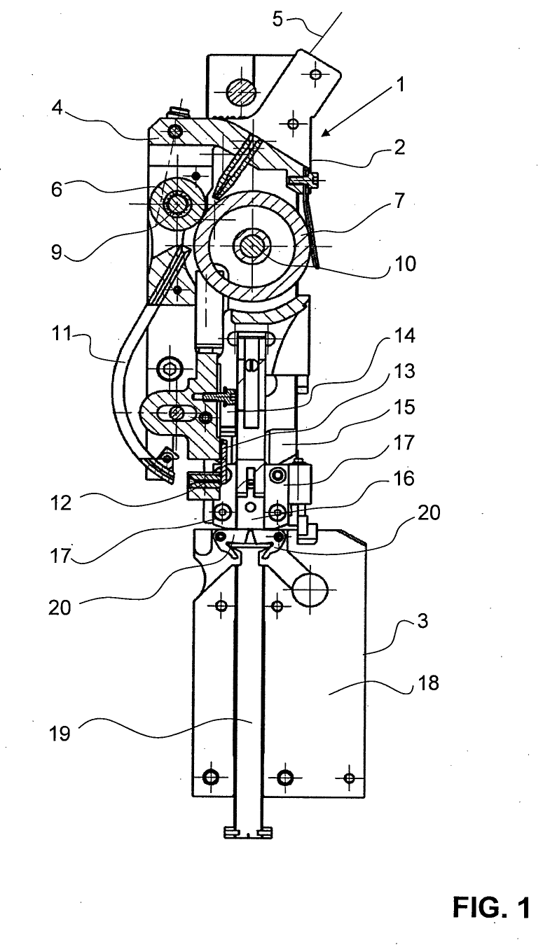

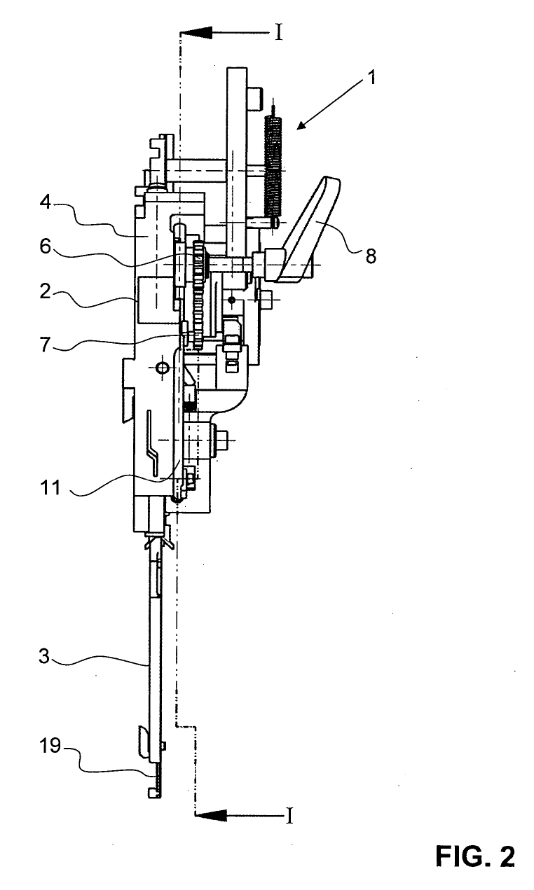

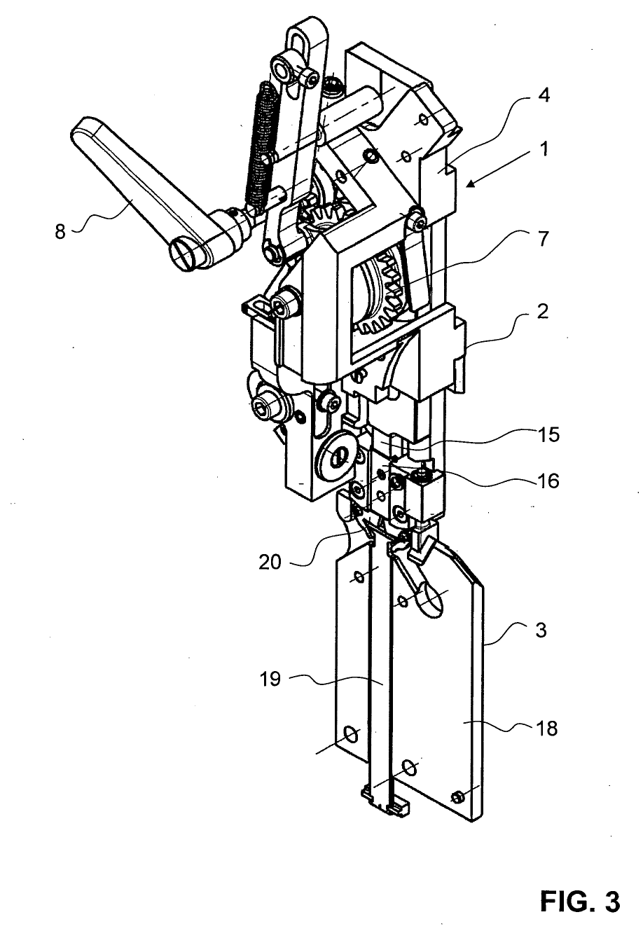

### DESCRIPTION OF THE PREFERRED EMBODIMENTS

The stitching device 1 has a housing 4, on which at least one stitching head 2 is mounted. The stitching head 2 is located, for example, in a gatherer-stitcher above a gathering chain, not shown, which in itself is already well known. Below the gathering chain there is a clincher 3. The printed products such as signatures, not shown, for example, to be stitched are conveyed between the stitching head 2 and the clincher 3.

The staples (not shown) are preformed from wire 5 in the stitching head 2. The wire 5 is drawn from a roll, not shown and fed by a curved tube 11 to a wire nozzle 12. To convey the wire 5, two feed rolls 6 and 7 are mounted on the frame 4 and are rotated by shafts 9 and 10, respectively. A lever 8 also allows the feed roll 6 to be turned manually. A wire cutter 13 is mounted on a shearing lever 14 above the wire nozzle 12. The wire cutter 13 cuts off pieces of wire from the wire 5, and each of the pieces of wire cut off in this way is formed into a staple by means that are already well known. To this end, a driver rod 15 moves a driver 16 and two benders 17 vertically in the known manner. The benders 17 bend the two free ends of the cut piece of wire downward by 90°.

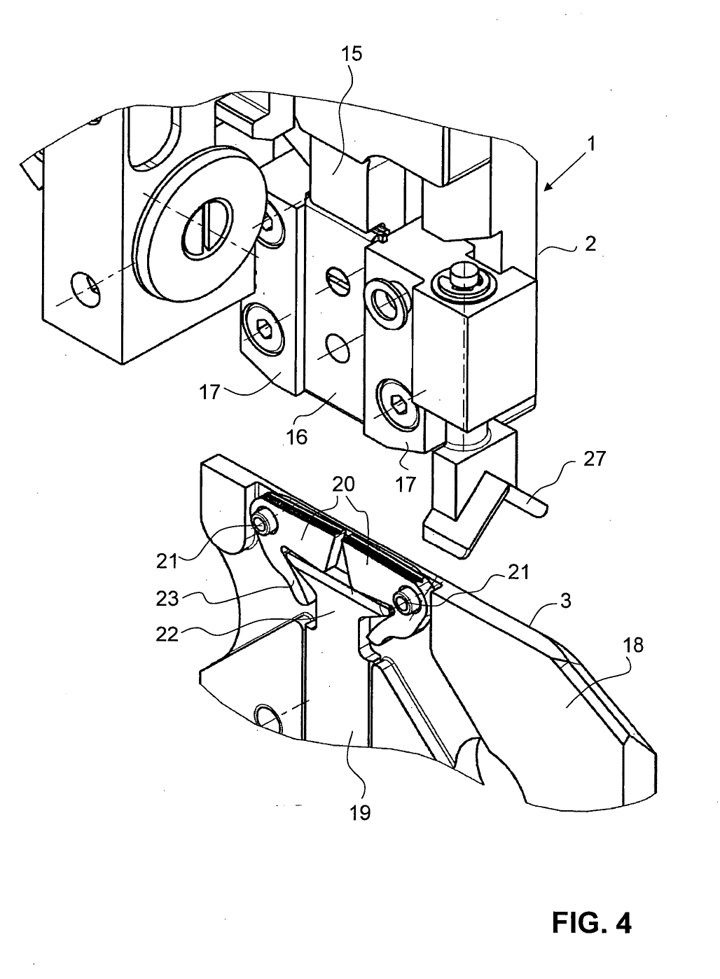

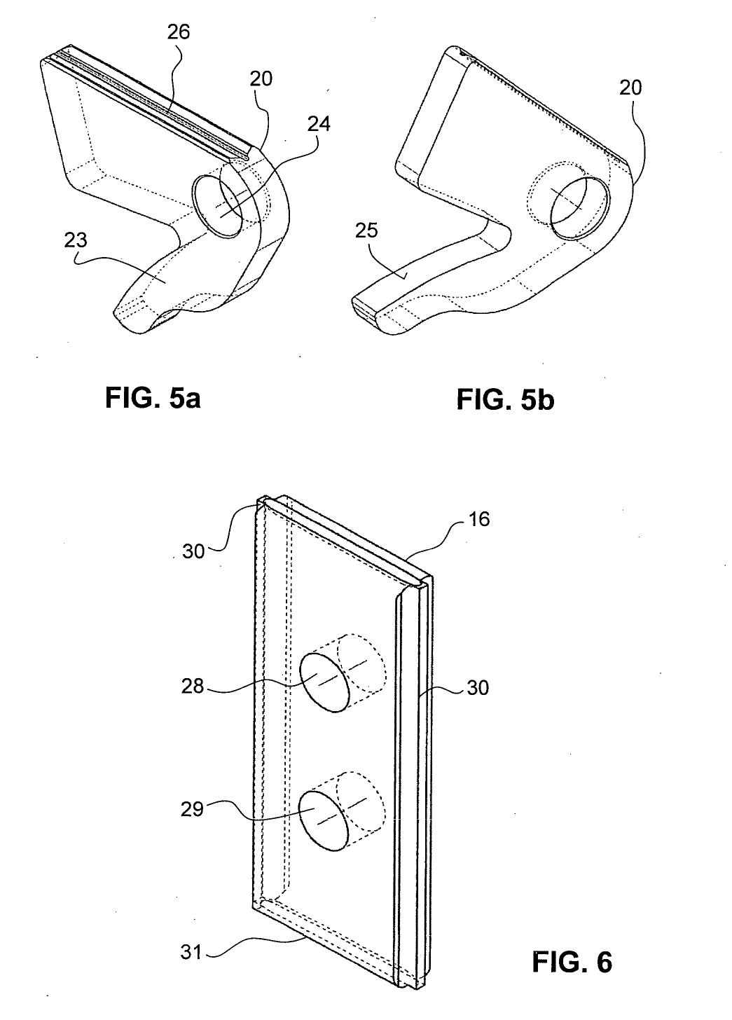

These preformed staples are driven into the product spine by the driver 16. Finally, the downwardly projecting ends are bent back by the clincher 3, so that these ends are parallel to the product spine. The staple is thus closed. To this end, the clincher 3 has two clincher plates 20 that are rotatably supported on a holder 18. As FIG. 4 shows, the clincher plates 20 are arranged with mirror symmetry to each other, and each can be rotated to a limited extent around an axis 21. The rotating motion is produced by a connecting rod 19, which is supported in a way that allows it to move vertically. The rod has a catch 22, which engages between the two clincher plates 20. When the connecting rod 19 moves downward, the arms 23 rotate the two clincher plates 20. To produce this movement, the catch 22 acts on the inner surface 25 (see FIG. 5b) of the arm 23.

Each of the clincher plates 20 has a V-shaped groove 26, which, in the position shown in FIG. 4, is parallel to the transport direction of the printed products. These grooves 26 serve the purpose of guiding, in a way that is already well known, the free ends of the preformed staple to be clinched. To this end, the clincher plates 20 are pivoted by the connecting rod 19 into the position shown in FIG. 4. Each of these clincher plates 20 has a mounting hole 24. During the stapling operation, the printed product to be stapled can be held steady by the vertically movable holder 27.

As shown in FIG. 6, the driver 16 has a plate-like design with two holes 28 and 29 by which it can be mounted on the driver rod 15. The driver 16 has two laterally projecting guide parts 30, which guide its vertical movement. The underside has an edge 31, which acts on the preformed staple to be driven in. It can easily be seen that the clincher plates 20 and the driver 16 are highly stressed parts, which must also be highly accelerated during the stapling operation. The benders 17, the connecting rod 19, the wire nozzle 12, the wire cutter 13 and the wire shearing lever 14 are also highly stressed, and some of them are accelerated as well. At least one of these parts is produced at least partly of engineering ceramic. The ceramic is preferably an oxide ceramic, especially a mixed-metal oxide ceramic. Oxide ceramic usually consists of more than 90% single-phase and single-component metal oxides. Examples of these metal oxides are aluminum oxide, magnesium oxide, and zirconium oxide. An example of a suitable mixed-metal oxide ceramic is aluminum titanate. Other oxide ceramics and mixed-metal oxide ceramics, however, are also well known.

The ceramic part is preferably produced by ceramic injection molding (CIM). In this injection-molding process, a very fine ceramic powder is mixed with a thermoplastic binder. This mixture can then be injected much like plastic. After removal from the mold, the intermediate product is pyrolyzed and sintered. Sintering is a production process that is usually carried out in three stages. This may be followed by a finishing process such as polishing with diamond tools. Important advantages of a part of this type are its high, longer-lasting dimensional stability compared to a part made of tool steel and its constant material quality. Compared to a part made of hard metal, this part has the important advantage that it is much less brittle and is therefore at hardly any risk of being destroyed during installation. Unlike hard metal, the surface cannot break off. Other advantages are its low density, e.g., 5 kg/dm³, which is less than that of steel; its good antifriction properties; and its high and constant surface quality. Other advantages are its heat resistance and low thermal expansion.

Other suitable areas of application for parts made of the specified ceramic include, in general, any highly stressed parts in other devices and machines for postpress finishing operations. These include especially sheet feeders, product gluing machines, and insert feeders. Examples of parts of these types are grippers, clamping devices, gripper pads, nozzles, grooved wheels and perforating disks, and latches, catches, and parts in suction devices.

While specific embodiments of the invention have been described in detail to illustrate the inventive principles, it will be understood that the invention may be embodied otherwise without departing from such principles.

I claim:

1. A stitching device for stapling printed products, the stitching device comprising a stitching head, with a driver and a bender for preforming a staple and for driving the staple through a product spine, and a clincher, with clincher plates for bending back open ends of the staple, wherein at least one part of the stitching head is at least partly of ceramic.

2. A stitching device according to claim 1, wherein the part is a sintered molded part.

3. A stitching device according to claim 1, wherein the part is produced from an oxide ceramic.

4. A stitching device according to claim 1, wherein the part is of a mixed-metal oxide ceramic.

5. A stitching device according to claim 1, wherein the part is comprised of at least two parts that are permanently connected to each other, one of the parts being of ceramic, and the other being of a different material.

6. A stitching device according to claim 5, wherein the different material is steel or a hard metal.

7. A stitching device according to claim 5, wherein the part is a wear part.

8. A stitching device according to claim 7, wherein the wear part is selected from the group consisting of a driver, a clincher plate, a bender, a centering foot, a connecting rod, a wire nozzle, a wire guide, a wire cutter, and a wire shearing lever or gear wheel.

9. A stitching device according to claim 1, wherein the part is an injection-molded part.
